(19) United States
(12) Patent Application Publication
(10) Pub. No.: US 2006/0138700 A1
(43) Pub. Date: Jun. 29, 2006

(54) Method and device for forming groove line in sheet-like member

(76) Inventor: Nobuyuki Suda, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/541,918

(22) PCT Filed: Jan. 9, 2004
(86) PCT No.: PCT/JP04/00088

§ 371 Date: Jan. 25, 2006

(30) Foreign Application Priority Data
Jan. 14, 2003 (JP) 2003-006218

(51) Int. Cl. B29C 47/00

(52) U.S. Cl. 264/284; 425/325; 264/210.1

(57) ABSTRACT

A sheet of a rubber material is rolled by a pair of rotating rolling rollers 12 and 13 opposed to each other to form a sheet 1. Sheets 1 are superposed and laminated to form a structural component of a tire. At least the rolling roller 12 is provided with an annular protrusion 20 and annular grooves 21 for shaping the sheet 1. Fine ridges 12a (31a) are formed in the surfaces of the annular protrusion 20 and the annular grooves 21. When the rolling rollers 12 and 13 are rotated to form the sheet 1, furrows and fine grooves 2 for releasing air are formed simultaneously in the surface of the sheet 1. The sheet 1 provided with the furrows and the fine grooves can be formed by a reduced number of manufacturing steps, while the fine grooves with the same shape can be formed.

### TECHNICAL FIELD

The present invention relates to a method of producing a sheet with grooves and an apparatus for carrying out the method.

### BACKGROUND ART

Sheets including inner liners of tires are wound round a forming drum in multiple layers and the multiple layers of the sheets are laminated together to form a structural component and a tire is formed by forming the structural component. In some cases, air is caught between the sheets when the sheets are laminated together.

Although air scarcely remains between the layered sheets when the sheets have smooth surfaces, once air is caught between the laminated sheets having the smooth surfaces, it is very difficult to remove the air completely from the layered sheets. Voids formed by the air remaining in the laminated sheets will deteriorate the quality of the tire.

A technique disclosed in JP 63-43125 U forms a plurality of grooves in a surface of a sheet to enable air caught between the sheets to escape through the grooves.

An unvulcanized rubber sheet disclosed in JP 63-43125 U is provided with a plurality of grooves in a surface thereof. Any method of forming the grooves is not mentioned in JP 63-43125 U. Generally, a plurality of grooves are formed in the surface of a rubber sheet by a method, such as a method disclosed in Japanese Patent. No. 3204747 or JP 59-99805 U, that presses the rubber sheet between a cylindrical ridge roller provided with a plurality of ridges and a cylindrical counter roller.

A groove forming process for forming grooves in the surface of a sheet is performed after a sheet forming process. When grooves are formed in a sheet after the sheet has been completed by rolling, grooves are formed in irregular shapes by the groove forming process due to the variation of the temperature of the rubber sheet that occurs depending on process conditions including processing speed of the sheet forming process.

When the sheet forming process includes an embossing process for forming protrusions and recesses in the surface of a rubber sheet, deep grooves can be formed in the protrusions but it is difficult to form grooves in the recesses by pressing the cylindrical ridge roller against the surface of the rubber sheet provided with the protrusions and recesses.

For example, suppose that a structural component of a tire is formed by superposing a plurality of sheets having a uniform thickness and is fabricated by rolling. If the plurality of sheets have different widths, namely, different dimensions across the length of the sheets, respectively, the structural component of the tire have an irregular thickness. When the cylindrical ridge roller is pressed against the surface of the structural component having an irregular thickness, grooves of a fixed depth cannot be formed in the surface of the structural component.

When a green tire is subjected to a tire forming process and/or a vulcanizing process, the green tire expands and deforms outward. Shoulders, namely, humps, of the green tire tend to expand more greatly than other parts. Therefore, when sheets having the same thickness are used for forming a green tire, the rubber layer of a vulcanized tire formed by vulcanizing the green tire will have an irregular thickness. To prevent this, sheets of an irregular thickness having parts corresponding to the shoulders (humps) given a thickness greater than those of other parts are often used for forming a tire to prevent irregular deformation. However, grooves of uniform depth cannot be formed in the surfaces of such sheets having an irregular thickness, by pressing the ridge roller against the surface of the sheet formed by rolling.

The present invention has been made in view of those problems and it is therefore an object of the present invention to provide a method of producing a sheet with grooves, capable of reducing manufacturing processes and of forming uniform grooves in a sheet irrespective of whether or not the sheet has been processed by an embossing process.

### DISCLOSURE OF THE INVENTION

The present invention provides a method of producing a sheet with grooves, the method comprising the steps of: preparing a pair of rolling rollers, at least one of which is an embossing roller having a peripheral surface provided with a plurality of ridges; and simultaneously forming a sheet by rolling and forming a plurality of grooves in a surface of the sheet by feeding a rubber material between the rotating pair of rolling rollers.

By this method, the steps of a manufacturing process can be reduced and working time can be curtailed by simultaneously forming the sheet and the plurality of grooves by feeding the rubber material between the pair of rolling rollers, at least one of the rollers being provided with the plurality of ridges in its surface.

This method is not subject to the variation of the temperature of the sheet that occurs depending on the sheet processing speed and uniform grooves can be formed even if the sheet has an irregular thickness. Consequently, a sheet of a stable, high quality can be manufactured.

According to the present invention, the embossing roller provided with the ridges, may have an embossing surface for forming an embossed surface in the surface of the sheet simultaneously with the forming of said ridges. Thus, furrows and a pattern of grooves can be simultaneously formed in the surface of the sheet by the embossing roller provided with the ridges and having the embossing surface, and the grooves are formed in uniform shape across any section of the sheet.

Typically, the embossing surface includes a plurality of circumferential surfaces having different circumferences.

According to the present invention, a sheet formed by extruding a rubber material by a roller-head extruder may be fed to and may be rolled by the pair of rolling rollers. The pair of rolling rollers may be a pair of calendar rollers.

An apparatus for producing a sheet with grooves in another aspect of the present invention comprises: a pair of rolling rollers opposed to each other to roll a workpiece fed thereto into a sheet, at least one of the pair of rolling rollers being an embossing roller having an embossing surface for shaping the sheet, said embossing surface having a plurality of ridges formed therein.

The effect of the sheet producing apparatus is the same as that of the sheet producing method.

Typically, the embossing surface includes a plurality of circumferential surfaces having different circumferences.

The rolling rollers may be included in a head of a roller-head extruder. The pair of rolling rollers may be a pair of calendar rollers.

Preferably, the ridges are formed in a pattern in the embossing surface. The pattern may be that of substantially parallel V-shaped ridges symmetrical with respect to a middle circumferential line contained in a plane perpendicular to the axis of the embossing roller and crossing the middle of the same axis, and extending with axial and circumferential components from the middle circumferential line toward the opposite ends of the embossing roller. The pattern may be a honeycomb pattern or may be any suitable pattern.

Desirably, the V-shaped ridges have a height in the range of 0.1 to 0.3 mm and a width in the range of 0.5 to 2.0 mm.

Preferably, the V-shaped ridges have a trapezoidal cross section.

### BRIEF DESCRIPTION OF THE DRAWINGS

FIG. 1 is a perspective view of a roller head extruder in a preferred embodiment of the present invention;

FIG. 2 is a front elevation of a roller head included in the roller head extruder shown in FIG. 1;

FIG. 3 is a fragmentary sectional view of an embossing surface of an embossing roller;

FIG. 4 is a fragmentary sectional view of an unvulcanized rubber sheet;

FIG. 5 is a perspective view for explaining the relation between the embossing roller and an unvulcanized rubber sheet;

FIG. 6 is a sectional view taken on the line VI-VI in FIG. 5;

FIG. 7 is a front view of a roller head included in a second embodiment of the present invention;

FIG. 8 is an enlarged, fragmentary plan view of an embossing surface; and

FIG. 9 is a sectional view taken on the line IX-IX in FIG. 8.

### BEST MODE FOR CARRYING OUT THE INVENTION

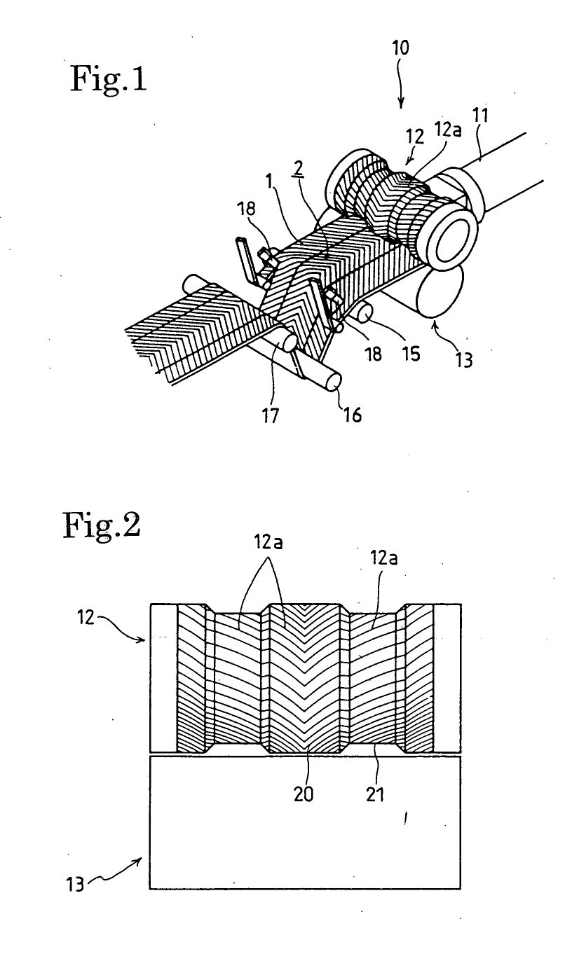

Preferred embodiments of the present invention will be described in connection with FIGS. 1 to 6.

A roller head extruder 10 used in a preferred embodiment of the present invention produces an unvulcanized rubber sheet 1. Rollers included in the roller head extruder 10 are changeable.

Referring to FIG. 1, the roller head extruder 10 is a rubber sheet forming apparatus formed by combining an extruder 11, and a roller head including a pair of rolling rollers 12 and 13 opposed to each other and extending across an extruding direction. A rubber material supplied to the extruder 11 is kneaded and forced through the orifice of a die by an internal screw. The extruded rubber material is rolled continuously by the pair of rolling rollers 12 and 13 to form an unvulcanized rubber sheet 1 of a predetermined sectional shape, namely, a predetermined profile.

The delivered unvulcanized rubber sheet 1 is guided by guide rollers 15, 16 and 17. A pair of trimming cutters 18 are disposed on the opposite sides of the unvulcanized rubber sheet 1 and spaced a predetermined distance apart from each other. The trimming cutters 18 trim off side parts of the unvulcanized rubber sheet 1 to adjust the width of the unvulcanized rubber sheet 1 to a predetermined width.

The unvulcanized rubber sheet 1 can be formed in a desired width by adjusting the distance between the pair of trimming cutters 18. The unvulcanized rubber sheet 1 is wound round a take-up roller in a roll or cut into strips. The roll of the unvulcanized rubber sheet or the unvulcanized rubber strips are delivered to a forming process.

The upper rolling roller 12 of the pair of rolling rollers 12 and 13 is an embossing roller 12 as shown in FIG. 2. The embossing roller 12 has an embossing surface for giving the unvulcanized rubber sheet 1 a predetermined sectional shape. As shown in FIG. 2, the embossing roller 12 has an annular protrusion 20 and annular grooves 21. Thus the embossing surface of the embossing roller 12 has circumferential surfaces respectively having different circumferences.

According to the present invention, the embossing surface is provided with a V-shaped pattern of a plurality of fine ridges 12a. The V-shaped pattern of the ridges 12a are symmetrical with respect to a plane containing the middle circumferential line of the annular protrusion 20 and perpendicular to the axis of the embossing roller 12. The ridges 12a extend in parallel and obliquely with axial and circumferential components from the middle circumferential line toward the opposite ends of the embossing roller 12.

Although the ridges 12a of the embossing roller 12 may be formed by a machining process, it is preferable to form the ridges 12a by an etching process because the etching process is suitable for forming the ridges 12a in uniform shape.

The roller head extruder 10 is constructed such that the embossing roller 12 having the patterned surface can be replaced with any one of other embossing rollers respectively having different sizes, different embossing surfaces and different patterns of ridges. The embossing roller 12 can be easily replaced with another embossing roller in a short time.

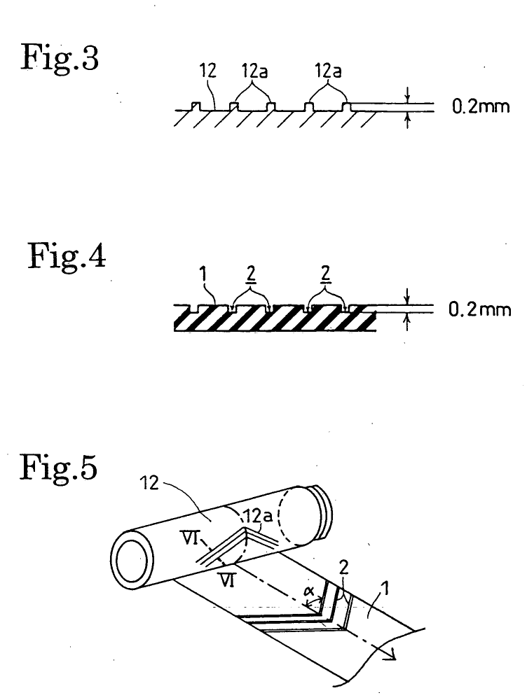

The Referring to FIG. 3, the ridges 12a formed in the embossing surface of the rolling roller 12, namely, the embossing roller 12, are arranged at equal intervals and have parallel side surfaces, a height in the range of 0.1 to 0.3 mm, for example, 0.2 mm, and a width in the range of 0.5 to 2.0 mm, for example, 1.5 mm. The distance between adjacent ridges 12a is in the range of 5.0 to 15.0 mm, for example, 10.0 mm. The lower rolling roller 13 has a smooth cylindrical surface.

The pair of rolling rollers 12 and 13 roll the extruded rubber material into a sheet and form a pattern of grooves and furrows simultaneously in the sheet to form the unvulcanized rubber sheet 1. A plurality of grooves 2 are formed in a pattern corresponding to that of the V-shaped pattern of the ridges 12a in a surface of the unvulcanized rubber sheet 1.

As shown in FIG. 4, the grooves 2 formed in the embossed surface of the unvulcanized rubber sheet 1 have uniform shape and depth. The depth of the grooves 2 is, for example, 0.2 mm.

Since the step of forming the unvulcanized rubber sheet 1 and that of forming the grooves 2 are carried out simultaneously, processing steps can be reduced and working time can be curtailed. Since the groove forming process is not affected by the variation of the temperature of the unvulcanized rubber sheet 1 due to variation of the processing speed, the uniform grooves can be formed and a sheet of a stable, high-quality sheet can be manufactured.

FIG. 5 shows the relation between the embossed unvulcanized rubber sheet 1 and the embossing roller 12, namely, the rolling roller 12. An angle α equal to half the angle between the opposite parts of the V-shaped pattern of each ridge 12a is, for example, 45°. Thus, the grooves 2 formed in the unvulcanized rubber sheet 1 have the same V-shaped pattern with the same angle α.

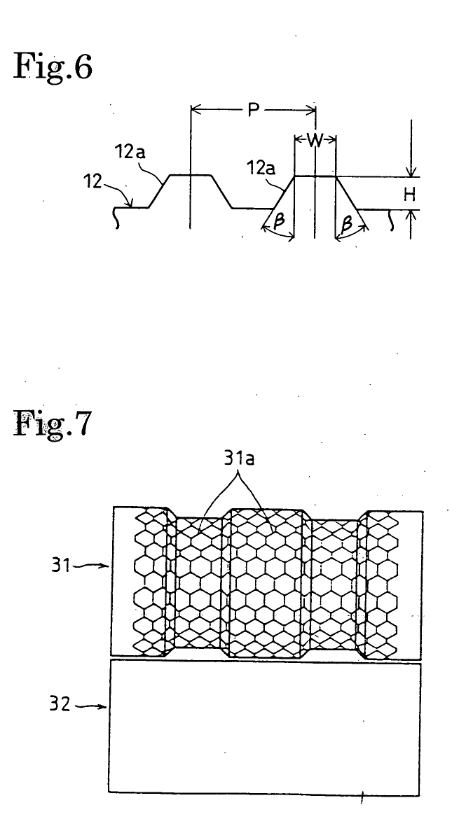

The ridge 12a of the rolling roller 12 has parallel side surfaces as shown in FIG. 3 in sectional view by way of example. Preferably, the ridge 12a has inclined side surfaces and a trapezoidal cross section as shown in FIG. 6 in a sectional view taken on the line VI-VI in FIG. 5. The trapezoidal ridges 12a shown in FIG. 6 have a trapezoidal cross section of a height H of 0.15±0.015 mm, and have a top surface of a width W of 1.5±0.1 mm. The trapezoidal ridges 12a are arranged at pitches P of 10 mm. Preferably, the side surfaces of the trapezoidal ridge 12a are inclined at an angle β of, for example, about 150 to a perpendicular to the top surface of the trapezoidal ridge 12a. The influence of the change of the shape of the ridges 12a with time on the shape of the grooves 2 can be limited to the least extent and the shape of the ridges 12a can be maintained, when the rolling roller 12 is provided with the trapezoidal ridges 12a with the gradually reduced widths toward the top. The grooves 2 formed in the surface of the unvulcanized rubber sheet 1 by the rolling roller 12 provided with the trapezoidal ridges 12a have a width of the groove opening larger than the width of the groove bottom. Such outwardly expanding grooves 2 are not closed easily.

The unvulcanized rubber sheets 1 provided with the many uniform grooves 2 in their surface are used as component members of a tire, such as inner liners, carcass plies, belts or side walls. The unvulcanized rubber sheets 1 are superposed and laminated on a forming drum to form a laminated structure. Air caught between adjacent unvulcanized rubber sheets 1 is able to escape from the laminated structure through the grooves 2. Thus, voids are not formed in the laminated structure by air remaining in the laminated structure and hence the laminated structure not having internal voids can be used as a structural component of a high-quality tire.

A second embodiment of the present invention will be described with reference to FIGS. 7 to 9.

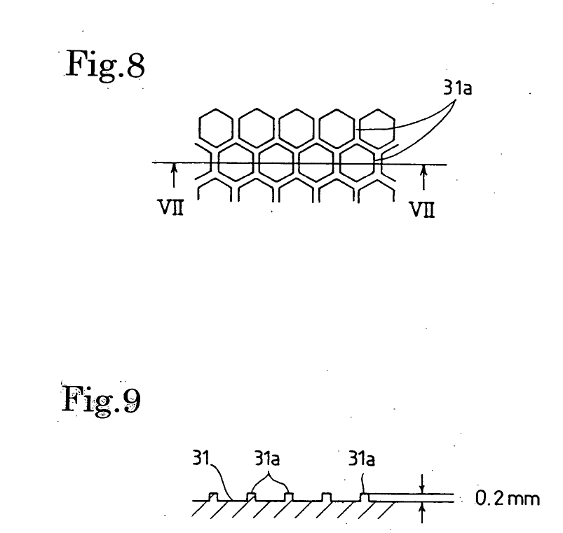

Referring to FIG. 7, a rolling roller 31 employed in the second embodiment has an external shape of a profile similar to that of the external shape of the rolling roller 12 shown in FIG. 2. As shown in FIG. 8, ridges 31a are formed in a honeycomb pattern in the surface of the rolling roller 31. As shown in FIG. 9, the ridges 31a are formed to have the same height of, for example 0.2 mm. A lower rolling roller 32 has a smooth, cylindrical surface.

The pair of rolling rollers 31 and 32 are built into the head of an extruder. The pair of rolling rollers 31 and 32 roll therebetween a rubber material extruded by the extruder into a sheet and form embossed grooves and a honeycomb pattern of fine grooves simultaneously in the sheet to form the unvulcanized rubber sheet. The honeycomb pattern of the fine grooves formed in the surface of the unvulcanized rubber sheet corresponds to the honeycomb pattern of the ridges 31a.

The grooves are formed uniformly in protruding parts and the recessed parts of the surface of the unvulcanized rubber sheet in the same depth of, for example 0.2 mm and in the same width of, for example, 1.5 mm.

The ridges of the rolling roller may be formed in any one of various patterns. Both the upper and the lower rolling roller may have embossing surfaces to form grooves in both the surfaces of the unvulcanized rubber sheet.

Preferably, the ridge 31a of the rolling roller 31 employed in the second embodiment are trapezoidal ridges as shown in FIG. 6.

A sheet forming apparatus provided with calendar rollers may be used instead of the roller head extruder. The calendar roller or both the calendar rollers are provided with a pattern of ridges to form grooves in an unvulcanized rubber sheet as the unvulcanized rubber sheet is being produced.

1. A method of producing a sheet with grooves, said method comprising the steps of:
preparing a pair of rolling rollers, at least one of which is an embossing roller having a peripheral surface provided with a plurality of ridges; and
simultaneously forming a sheet by rolling and forming a plurality of grooves in a surface of the sheet by feeding a rubber material between the rotating pair of rolling rollers.

2. The method of producing a sheet with grooves according to claim 1, wherein the embossing roller provided with the ridges, has an embossing surface for forming an embossed surface in the surface of the sheet simultaneously with the forming of said ridges.

3. The method of producing a sheet with grooves according to claim 2, wherein the embossing surface includes a plurality of circumferential surfaces respectively having different circumferences.

4. The method of producing a sheet with grooves according to claim 1, comprising a step of feeding a sheet formed by extruding a rubber material with a roller-head extruder to the pair of rolling rollers.

5. The method of producing a sheet with grooves according to claim 1, wherein the pair of rolling rollers are a pair of calendar rollers.

6. An apparatus for producing a sheet with grooves comprising:
a pair of rolling rollers opposed to each other to roll a workpiece fed thereto into a sheet,
at least one of the pair of rolling rollers being an embossing roller having an embossing surface for shaping the sheet, said embossing surface having a plurality of ridges formed therein.

7. The apparatus for producing a sheet with grooves according to claim 6, wherein the embossing surface has a plurality of circumferential surfaces having different circumferences.

8. The apparatus for producing a sheet with grooves according to claim 6, wherein the rolling rollers are included in a head of a roller-head extruder.

9. The apparatus for producing a sheet with grooves according to claim 6, wherein the pair of rolling rollers are a pair of calendar rollers.

10. The apparatus for producing a sheet with grooves according to claim 6, wherein the ridges are formed in a predetermined pattern in the embossing surface.

11. The apparatus for producing a sheet with grooves according to claim 10, wherein the pattern is that of substantially parallel V-shaped ridges symmetrical with respect to a middle circumferential line contained in a plane perpendicular to an axis of the embossing roller and crossing the middle of the same axis, and extending with axial and circumferential components from the middle circumferential line toward the opposite ends of the embossing roller.

12. The apparatus for producing a sheet with grooves according to claim 10, wherein the pattern of the ridges is a honeycomb pattern.

13. The apparatus for producing a sheet with grooves according to claim 6, wherein the V-shaped ridges have a height in a range of 0.1 to 0.3 mm.

14. The apparatus for producing a sheet with grooves according to claim 6, wherein the V-shaped ridges have a width in a range of 0.5 to 2.0 mm.

15. The apparatus for producing a sheet with grooves according to claim 6, wherein the V-shaped ridges have a trapezoidal cross section.
